(19) United States
(12) Patent Application Publication
(10) Pub. No.: US 2023/0204453 A1
(43) Pub. Date: Jun. 29, 2023

(54) TEST APPARATUS

(71) Applicant: Samsung Display Co., Ltd., Yongin-si (KR)

(72) Inventor: GABTAE KIM, Asan-si (KR)

(21) Appl. No.: 17/941,615

(22) Filed: Sep. 9, 2022

(30) Foreign Application Priority Data
Dec. 28, 2021 (KR) 10-2021-0190306

(51) Int. Cl. G01M 7/08

(52) U.S. Cl. CPC G01M 7/08

(57) ABSTRACT

A test apparatus includes a stage on which a test object is disposed, a first support part extending in a first direction, a second support part extending in the first direction and spaced apart from the first support part in a second direction crossing the first direction with the stage interposed therebetween, a first height guide part movably coupled with the first support part and extending in a third direction crossing the first direction and the second direction, a second height guide part movably coupled with the second support part and extending in the third direction, a horizontal guide part movably coupled with the first height guide part and the second height guide part, and a falling body providing part movably coupled with the horizontal guide part.

This application claims priority to Korean Patent Application No. 10-2021-0190306, filed on Dec. 28, 2021, and all the benefits accruing therefrom under 35 U.S.C. § 119, the content of which in its entirety is herein incorporated by reference.

### BACKGROUND

### 1. Field

The present disclosure relates to a test apparatus. More particularly, the present disclosure relates to a test apparatus capable of improving test reliability.

### 2. Description of the Related Art

A test apparatus may be used to test an impact resistance of an electronic device. The electronic device may include a display device, and the display device may include various electronic components, such as a display panel and an electronic module. When an external force is applied to the display device, a window may be cracked or a bright spot phenomenon may occur.

### SUMMARY

The present disclosure provides a test apparatus capable of improving test reliability.

Embodiments of the invention provide a test apparatus including a stage on which a test object is disposed, a first support part extending in a first direction, a second support part extending in the first direction and spaced apart from the first support part in a second direction crossing the first direction with the stage interposed therebetween, a first height guide part movably coupled with the first support part and extending in a third direction crossing the first direction and the second direction, a second height guide part movably coupled with the second support part and extending in the third direction, a horizontal guide part movably coupled with the first height guide part and the second height guide part, and a falling body providing part movably coupled with the horizontal guide part.

In an embodiment, the falling body providing part may include an insertion module into which the falling body is inserted and an opening and closing module which controls a drop of the falling body.

In an embodiment, the insertion module may have a column shape through which a penetration hole is defined, and the falling body may pass through the penetration hole.

In an embodiment, the test apparatus may further include a support module disposed between the insertion module and the opening and closing module.

In an embodiment, the insertion module may include a sidewall through which an opening is defined.

In an embodiment, the insertion module may include a transparent material.

In an embodiment, the test apparatus may further include a laser module which radiates a laser beam to the insertion module to mark a position to which the falling body is provided, and the laser module may rotate with respect to the insertion module.

In an embodiment, the opening and closing module may be opened and closed by an air cylinder opening and closing method to drop the falling body.

In an embodiment, the opening and closing module may be opened and closed by an electronic opening and closing method using a servo motor to drop the falling body.

In an embodiment, the second height guide part may include a vertical coordinate part extending in the third direction.

In an embodiment, the test apparatus may further include a zero point control part coupled with the vertical coordinate part, where the zero point control part controls a zero point of the vertical coordinate part based on a type of the falling body.

In an embodiment, the falling body providing part may be provided in plural.

In an embodiment, the falling body providing part may include an opening and closing module which controls a drop of the falling body and a rotation falling body providing part which rotates with respect to the opening and closing module and sequentially provides a plurality of the falling bodies to the opening and closing module.

In an embodiment, the test apparatus may further include a camera module which photographs the test object, a determination part which determines whether a defect occurs in the test object, and a control part which controls a position of the falling body providing part, an operation of the camera module, and an operation of the determination part.

Embodiments of the invention provide a test apparatus including a position guide part and a falling body providing part coupled with the position guide part. In such embodiments, the falling body providing part includes an insertion module having a column shape, where a penetration hole into which a falling body is inserted is defined in the insertion module, a support module which supports the insertion module, an opening and closing module disposed under the support module, where the opening and closing module may control a drop of the falling body, and a laser module which radiates a laser beam via the insertion module to mark a position to which the falling body is provided.

In an embodiment, an opening may be defined through a sidewall of the insertion module and a sidewall of the support module.

In an embodiment, the insertion module may include a transparent material.

In an embodiment, the position guide part may include a first support part extending in a first direction, a second support part extending in the first direction and spaced apart from the first support part in a second direction crossing the first direction, a first height guide part movably coupled with the first support part and extending in a third direction crossing the first direction and the second direction, a second height guide part movably coupled with the second support part and extending in the third direction, and a horizontal guide part movably coupled with the first height guide part and the second height guide part. In such an embodiment, the falling body providing part may be movably coupled with the horizontal guide part.

In an embodiment, the first height guide part may further include a vertical coordinate part extending in the third direction and a zero point control part coupled with the first height guide part, where the zero point control part may control a zero point of the vertical coordinate part based on a type of the falling body.

In an embodiment, the falling body providing part may further include a rotation falling body providing part which rotates with respect to the opening and closing module and sequentially provides a plurality of the falling bodies to the opening and closing module.

According to embodiments of the invention, the position of the falling body providing part is able to be represented in coordinates, and the impact resistance test is performed based on accurate coordinate data. Thus, a reliability with respect to the test is improved. In such embodiments, since the position to which the falling body is dropped is marked using the laser module, an accuracy in dropping of the falling body during the test is improved, and the reliability with respect to the test is improved.

According to embodiments of the invention, a simulation falling body is used to compensate for the deformation of the falling body due to the drop and to improve the test accuracy, and the control part remotely controls the test procedure to automatically perform the test. Thus, the test time is shortened, and the test accuracy is improved.

According to embodiments of the invention, the rotation falling body providing part in which plural falling bodies are mounted is used, and thus, the time consumed to mount the falling body is reduced and a test efficiency is improved. In such embodiments, a plurality of falling body providing parts may be used to perform the test under a variety and complex test environments.

### BRIEF DESCRIPTION OF THE DRAWINGS

The above and other features of embodiments of the present disclosure will become readily apparent by reference to the following detailed description when considered in conjunction with the accompanying drawings, in which:

FIGS. 1A and 1B are perspective views of a display device according to an embodiment of the present disclosure;

FIG. 2 is a perspective view of a test apparatus according to an embodiment of the present disclosure;

FIG. 3A is a plan view of a test object according to an embodiment of the present disclosure;

FIG. 3B is a view of a display device according to an embodiment of the present disclosure;

FIG. 4 is a plan view of a test object and an evaluation sheet according to an embodiment of the present disclosure;

FIG. 5 is a cross-sectional view of a falling body providing part according to an embodiment of the present disclosure;

FIG. 6A is a perspective view of an insertion module according to an embodiment of the present disclosure;

FIG. 6B is a plan view of an insertion module according to an embodiment of the present disclosure;

FIG. 7A is a perspective view of an insertion module according to an alternative embodiment of the present disclosure;

FIG. 7B is a plan view of an insertion module according to an alternative embodiment of the present disclosure;

FIGS. 8A and 8B are views of a portion of a test apparatus according to an embodiment of the present disclosure;

FIGS. 9A to 9D are views of falling body according to embodiments of the present disclosure;

FIG. 10 is a perspective view of a test apparatus according to an embodiment of the present disclosure;

FIG. 11A is a view of a cracked window according to an embodiment of the present disclosure;

FIG. 11B is a view of a bright spot defect according to an embodiment of the present disclosure;

FIG. 12A is a perspective view of a test apparatus according to an embodiment of the present disclosure;

FIG. 12B is a view of a rotation falling body providing part according to an embodiment of the present disclosure; and

FIG. 13 is a perspective view of a test apparatus according to an embodiment of the present disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In the present disclosure, it will be understood that when an element (or area, layer, or portion) is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content. “Or” means “and/or.” As used herein, the term “and/or” may include any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present disclosure. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.”

Spatially relative terms, such as “beneath”, “below”, “lower”, “above”, “upper” and the like, may be used herein for ease of description to describe one element or feature's relationship to another elements or features as shown in the figures.

It will be further understood that the terms “comprises” and/or “comprising,” or “include” and/or “including”, when used in this specification, specify the presence of stated features, integers, steps, operations, elements, and/or components, but do not preclude the presence or addition of one or more other features, integers, steps, operations, elements, components, and/or groups thereof.

The term “part” or “unit” as used herein is intended to mean a software component or a hardware component that performs a specific function. The hardware component may include, for example, a field-programmable gate array (FPGA) or an application-specific integrated circuit (ASIC). The software component may refer to an executable code and/or data used by the executable code in an addressable storage medium. Thus, the software components may be, for example, object-oriented software components, class components, and task components, and may include processes, functions, attributes, procedures, subroutines, segments of program code, drivers, firmware, micro codes, circuits, data, a database, data structures, tables, arrays, or variables.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present disclosure will be described in detail with reference to the accompanying drawings.

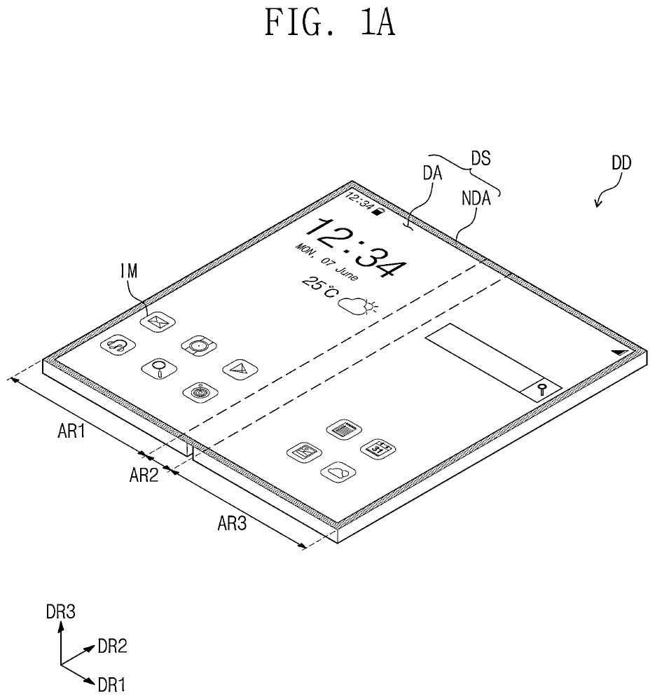

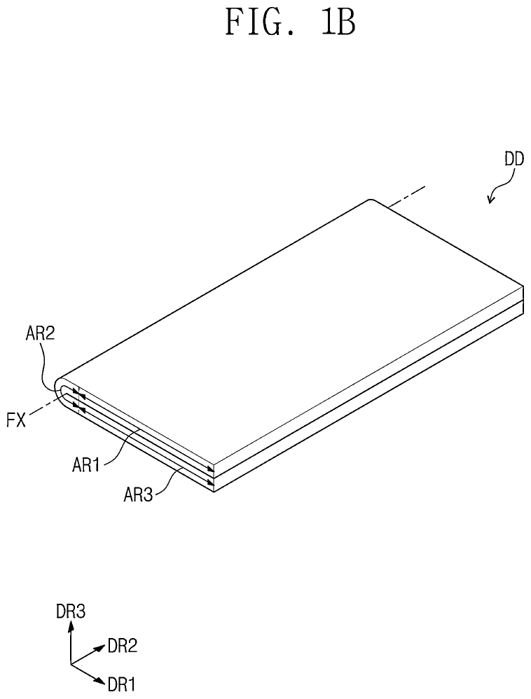

FIGS. 1A and 1B are perspective views of a display device DD according to an embodiment of the present disclosure. FIG. 1A shows the display device DD in an unfolded state, and FIG. 1B shows the display device DD in a folded state.

Referring to FIGS. 1A and 1B, an embodiment of the display device DD may include a display surface DS defined by a first direction DR1 and a second direction DR2 crossing the first direction DR1. The display device DD may provide an image IM to a user through the display surface DS.

The display surface DS may include a display area DA and a non-display area NDA around the display area DA. The display area DA may display the image IM, and the non-display area NDA may not display the image IM. The non-display area NDA may surround the display area DA, however, it should not be limited thereto or thereby, and alternatively, a shape of the display area DA and a shape of the non-display area NDA may be variously modified.

Hereinafter, a direction substantially perpendicular to a plane defined by the first direction DR1 and the second direction DR2 may be referred to as a third direction DR3. In the present disclosure, the expression “when viewed in a plane” or “when viewed in a plan view” may mean a state of being viewed in the third direction DR3 or a thickness direction of the display device DD.

The display device DD may include a first area AR1, a second area AR2, and a third area AR3. The first area AR1, the second area AR2, and the third area AR3 may be sequentially arranged in the first direction DR1. The second area AR2 may be referred to as a foldable area, and the first and third areas AR1 and AR3 may be referred to as non-foldable areas.

In an embodiment, as shown in FIG. 1B, the second area AR2 may be folded with respect to a folding axis FX substantially parallel to the second direction DR2. The second area AR2 may have a predetermined curvature and a radius of curvature when the display device DD is in the folded state. The display device DD may be inwardly folded (inner-folding) such that the first area AR1 may face the third area AR3 and the display surface DS may not be exposed to the outside.

According to an embodiment, the display device DD may be outwardly folded (outer-folding) such that the display surface DS may be exposed to the outside. According to an embodiment, the display device DD may be provided such that the inner-folding operation or the outer-folding operation may be repeated from an unfolding operation. According to an embodiment, the display device DD may be provided to selectively carry out any one of the unfolding operation, the inner-folding operation, and the outer-folding operation.

FIGS. 1A and 1B show an embodiment where the display device DD is a foldable display device, however, a shape and a type of the display device DD should not be limited thereto or thereby. In an alternative embodiment, for example, the display device DD may be flexible or rigid.

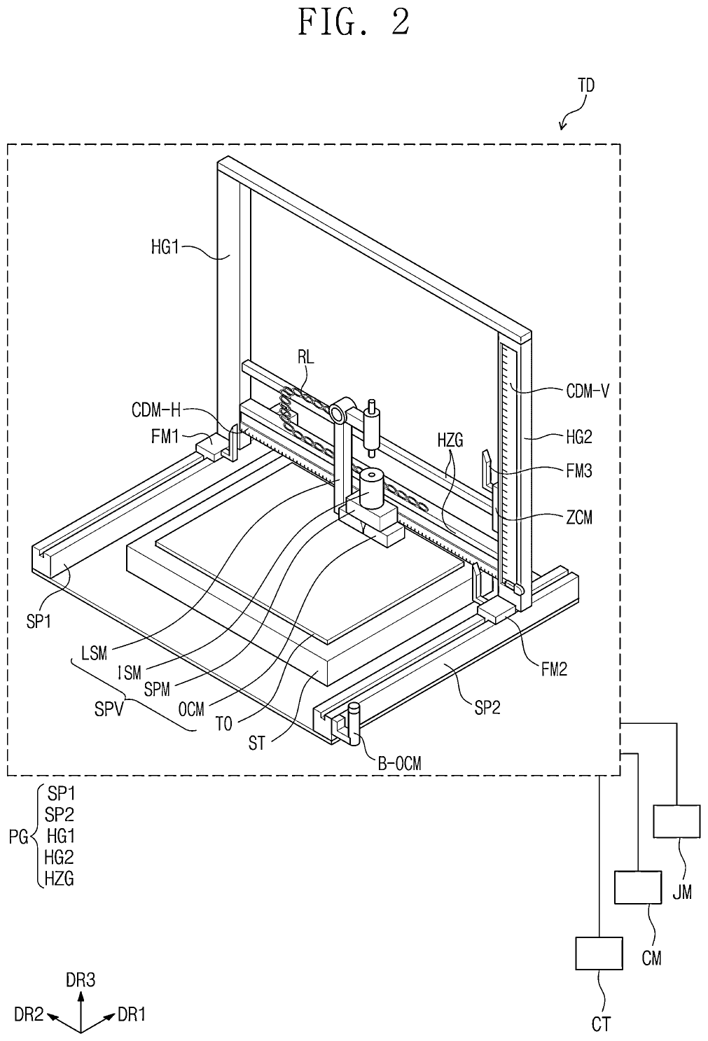

FIG. 2 is a perspective view of a test apparatus TD according to an embodiment of the present disclosure.

Referring to FIG. 2, an embodiment of the test apparatus TD may include a stage ST, a first support part SP1, a second support part SP2, a first height guide part HG1, a second height guide part HG2, a horizontal guide part HZG, a falling body providing part SPV, a camera part CM, a determination part JM, and a control part CT.

A test object TO may be disposed on the stage ST. The first support part SP1 and the second support part SP2 may extend in the first direction DR1. The first support part SP1 and the second support part SP2 may be disposed spaced apart from each other in the second direction DR2 with the stage ST interposed therebetween.

The first height guide part HG1 may extend in the third direction DR3. The first height guide part HG1 may be movably coupled to the first support part SP1 and may move in a direction substantially parallel to the first direction DR1 on the first support part SP1.

The second height guide part HG2 may extend in the third direction DR3. The second height guide part HG2 may be disposed spaced apart from the first height guide part HG1 in the second direction DR2. The second height guide part HG2 may be movably coupled to the second support part SP2 and may move in the direction substantially parallel to the first direction DR1 on the second support part SP2. A distance in which the first height guide part HG1 moves in the direction parallel to the first direction DR1 may be the same as a length in which the second height guide part HG2 moves in the direction parallel to the first direction DR1.

The horizontal guide part HZG may extend in the second direction DR2. The horizontal guide part HZG may be connected between the first height guide part HG1 and the second height guide part HG2 and may be coupled to the first height guide part HG1 and the second height guide part HG2 to be movable in a direction substantially parallel to the third direction DR3.

The falling body providing part SPV may be movably coupled to the horizontal guide part HZG. A rail RL may connect the falling body providing part SPV and the horizontal guide part HZG to each other. The rail RL may effectively prevent the falling body providing part SPV from slipping when the falling body providing part SPV moves. The falling body providing part SPV may move in a direction parallel to the second direction DR2 on the horizontal guide part HZG.

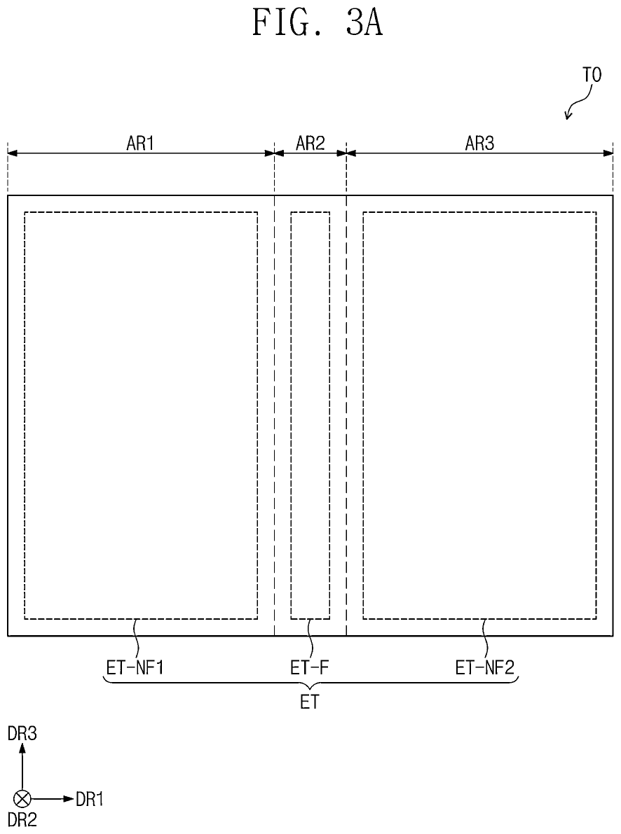

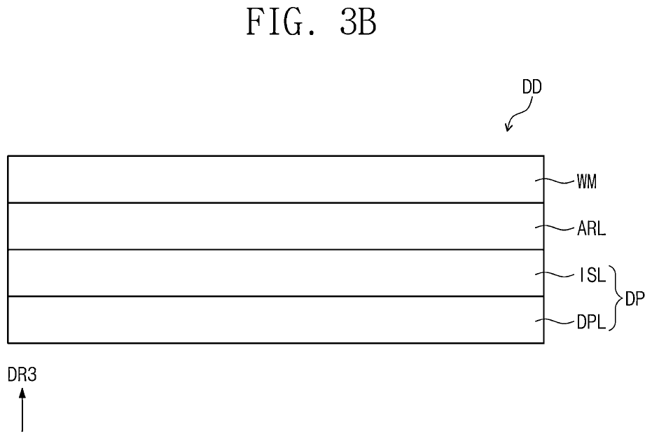

In an impact resistance test, the horizontal guide part HZG coupled with the falling body providing part SPV may be connected to the first height guide part HG1 and the second height guide part HG2 to move in the third direction DR3, and the first height guide part HG1 and the second height guide part HG2 may move in the first direction DR1. Accordingly, the falling body providing part SPV may move freely in the first direction DR1, the second direction DR2, and the third direction DR3, and thus, the falling body providing part SPV may be positioned in an evaluation area ET (refer to FIG. 3A) by a tester in the test apparatus TD.

The first support part SP1, the second support part SP2, the first height guide part HG1, the second height guide part HG2, and the horizontal guide part HZG may serve as components to control a position of the falling body providing part SPV. The first support part SP1, the second support part SP2, the first height guide part HG1, the second height guide part HG2, and the horizontal guide part HZG may be collectively referred to as a position guide part PG.

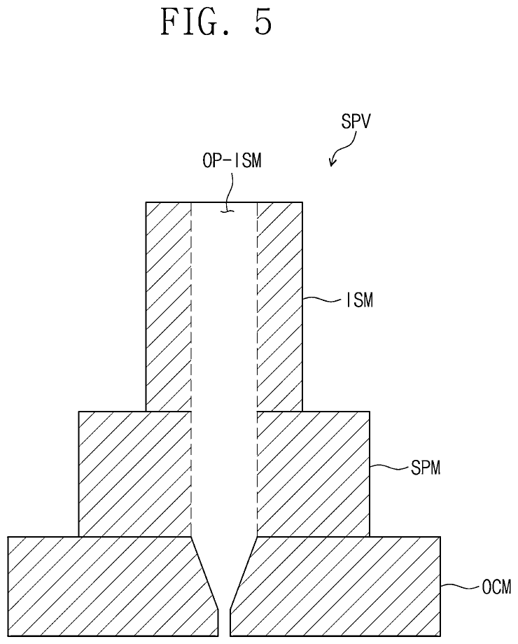

The falling body providing part SPV may include an insertion module ISM, a support module SPM, an opening and closing module OCM, and a laser module LSM. The configurations of the falling body providing part SPV will be described in detail with reference to FIG. 5.

After the impact resistance test, a microscope (not shown) may be used to determine the test results. According to an embodiment, the test result may be obtained by photographing the test object TO disposed on the stage ST using the camera part CM. The determination part JM may determine whether the test object TO is defected based on the image photographed by the camera part CM. The control part CT may control the position of the falling body providing part SPV and an operation of the camera part CM and the determination part JM. The control part CT may remotely control the test process and perform the test automatically. Accordingly, a process time may be shortened, and a test accuracy may be improved.

A vertical coordinate part CDM-V may be coupled to the second height guide part HG2. The vertical coordinate part CDM-V may extend in the third direction DR3. The vertical coordinate part CDM-V may include a scale ruler and may measure a distance in which the horizontal guide part HZG coupled to the falling body providing part SPV moves in the third direction DR3. FIG. 2 shows a structure in which the vertical coordinate part CDM-V is coupled to the second height guide part HG2 as a representative example, however, a coupling position of the vertical coordinate part CDM-V should not be limited thereto or thereby. In an alternative embodiment, for example, the vertical coordinate part CDM-V may be coupled to the first height guide part HG1.

A horizontal coordinate part CDM-H may be coupled to the horizontal guide part HZG. The horizontal guide part HZG may extend in the second direction DR2. The horizontal coordinate part CDM-H may include a scale ruler and may measure a distance in which the horizontal guide part HZG coupled to the falling body providing part SPV moves in the second direction DR2.

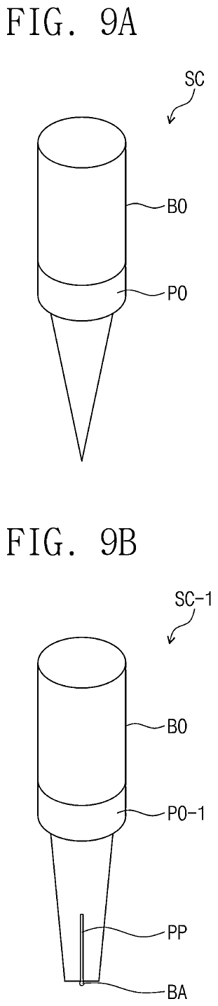

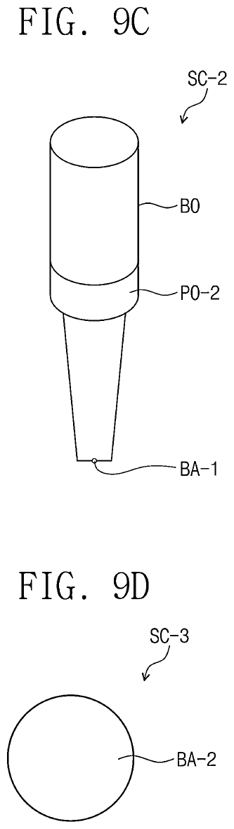

A zero point control part ZCM may be coupled to the vertical coordinate part CDM-V. A zero point of the vertical coordinate part CDM-V may be adjusted depending on a type of the falling body SC (refer to FIG. 9A) provided to the falling body providing part SPV. In an embodiment, for example, the falling body SC is installed at the falling body providing part SPV, and then, a height in the third direction DR3 at which a nip portion PP (refer to FIG. 9A) of the falling body SC makes contact with the test object TO may be adjusted to the zero point. After setting the height in the third direction DR3 to the zero point using the zero point control part ZCM, a position from which the falling body SC is dropped may be accurately determined using the scale ruler of the vertical coordinate part CDM-V. Accordingly, the height may be set to be exactly the same as each other when performing repeated impact evaluations at the same height.

According to an embodiment of the present disclosure, the position of the falling body providing part SPV may be represented in coordinates by the horizontal coordinate part CDM-H, the vertical coordinate part CDM-V, and the zero point control part ZCM, and the impact resistance test may be performed based on accurate coordinate data. Accordingly, a reliability in the impact resistance test may be improved.

A first fixing part FM1 may control a movement of the first height guide part HG1 in the first direction DR1. A second fixing part FM2 may control a movement of the second height guide part HG2 in the first direction DR1. The first and second height guide parts HG1 and HG2 may move in the direction parallel to the first direction DR1 and may be fixed to a position to be tested by the first and second fixing parts FM1 and FM2. A third fixing part FM3 may control a movement of the horizontal guide part HZG in the third direction DR3. The horizontal guide part HZG may move in the direction parallel to the third direction DR3 and may be fixed to a position to be tested by the third fixing part FM3.

FIG. 3A is a plan view of the test object TO according to an embodiment of the present disclosure.

Referring to FIG. 3A, an embodiment of the test object TO may include a plurality of evaluation areas ET-NF1, ET-F, and ET-NF2. The evaluation areas ET-NF1, ET-F, and ET-NF2 may include a first non-folding evaluation area ET-NF1, a folding evaluation area ET-F, and a second non-folding evaluation area ET-NF2.

The first non-folding evaluation area ET-NF1, the folding evaluation area ET-F, and the second non-folding evaluation area ET-NF2 may correspond to the first area AR1, the second area AR2, and the third area AR3, respectively. The first area AR1 and the third area AR3 may correspond to a non-folding area, and the second area AR2 may correspond to a folding area. Different from the first area AR1 and the third area AR3, the second area AR2 may have an internal structure that is easily folded. In an embodiment, for example, the second area AR2 may have a structure with elasticity, and the second area AR2 may have a durability weaker than a durability of the first area AR1 and the third area AR3. Accordingly, an impact resistance evaluation standard with respect to the folding evaluation area ET-F may be different from an impact resistance evaluation standard with respect to the first and second non-folding evaluation areas ET-NF1 and ET-NF2.

FIG. 3B is a view of the display device DD according to an embodiment of the present disclosure.

Referring to FIG. 3B, an embodiment of the display device DD may be the test object TO (refer to FIG. 2) of the test apparatus TD (refer to FIG. 2). The display device DD may include a display panel DP, an anti-reflective layer ARL, and a window WM. The display panel DP may include a display layer DPL and an input sensor layer ISL.

The display layer DPL may be a light emitting type display layer. In an embodiment, for example, the display layer DPL may be an organic light emitting display layer, an inorganic light emitting display layer, an organic-inorganic light emitting display layer, a micro-light emitting diode (LED) display layer, or a nano-LED display layer.

The input sensor layer ISL may be disposed on the display layer DPL. The input sensor layer ISL may sense an external input applied thereto from the outside. In an embodiment, for example, the external input may be a user's input. The user's input may include a variety of external inputs, such as a part of user's body, light, heat, pen, or pressure.

The input sensor layer ISL may be formed on the display layer DPL through successive processes. In such an embodiment, the input sensor layer ISL may be disposed directly on the display layer DPL. In the present disclosure, the expression “a component A is disposed directly on a component B” means that no intervening elements are present between the component A and the component B. That is, an adhesive member may not be disposed between the input sensor layer ISL and the display layer DPL.

The anti-reflective layer ARL may be disposed on the input sensor layer ISL. The anti-reflective layer ARL may reduce a reflectance with respect to an external light. The anti-reflective layer ARL may be disposed directly on the input sensor layer ISL through successive processes. According to an embodiment, the anti-reflective layer ARL may be attached to the input sensor layer ISL or the window WM by an adhesive layer. According to an embodiment, the anti-reflective layer ARL may be omitted.

The window WM may be disposed on the anti-reflective layer ARL. The window WM and the anti-reflective layer ARL may be coupled to each other by an adhesive layer. The adhesive layer may be a pressure sensitive adhesive (PSA) film or an optically clear adhesive (OCA).

The window WM may include at least one base layer. The base layer may be a glass substrate or a synthetic resin film. The window WM may have a multi-layer structure. The window WM may include a thin film glass substrate and a synthetic resin film disposed on the thin film glass substrate. The thin film glass substrate and the synthetic resin film may be coupled to each other by an adhesive layer, and the adhesive layer and the synthetic resin film may be separated from the thin film glass substrate to be replaced.

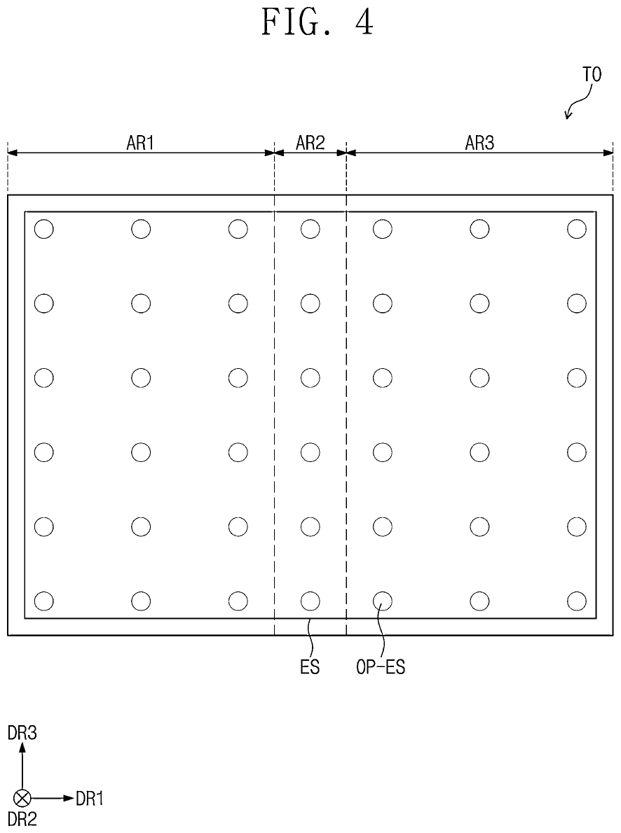

FIG. 4 is a plan view of the test object TO and an evaluation sheet ES according to an embodiment of the present disclosure.

Referring to FIG. 4, the evaluation sheet ES may be disposed on the test object TO. A test opening OP-ES may be defined through the evaluation sheet ES. The test opening OP-ES of the evaluation sheet ES may be disposed to overlap the first area AR1, the second area AR2, and the third area AR3. A portion of the test object TO may be exposed through the test opening OP-ES. The test opening OP-ES may be formed at a position of the test object TO, which is to be evaluated by the test apparatus TD (refer to FIG. 2).

The evaluation sheet ES may have various shapes depending on the purpose and the method of the test. FIG. 4 shows an embodiment with forty two (42) test openings OP-ES each having a circular shape as a representative example, however, the shape and the number of the test openings OP-ES should not be limited thereto or thereby. In an embodiment, for example, the shape and the size of the test opening OP-ES may be variously modified depending on the type and the size of the falling body SC (refer to FIG. 9A) that is to be tested, and the number of the test openings OP-ES may be variously modified depending on the purpose and the method of the test.

FIG. 5 is a cross-sectional view of the falling body providing part SPV according to an embodiment of the present disclosure.

Referring to FIG. 5, an embodiment of the falling body providing part SPV may include the insertion module ISM, the support module SPM, and the opening and closing module OCM. The falling body providing part SPV may drop the falling body SC (refer to FIG. 9A). The falling body providing part SPV may have a structure to maintain a drop direction and a drop position of the falling body SC without inclination when the falling body is dropped.

The insertion module ISM may have a column shape provided with a penetration hole OP-ISM through which the falling body SC passes. The shape of the penetration hole OP-ISM may be variously modified depending on the type of the falling body SC. The type of the falling body SC is described later. In an embodiment, the insertion module ISM may include a transparent material. In such an embodiment where the insertion module ISM includes the transparent material, whether the falling body SC is placed or not from the outside of the insertion module ISM may be observed, and thus, the speed of operating the test apparatus TD (refer to FIG. 2) may be improved. The support module SPM may be disposed under the insertion module ISM. The support module SPM may support the insertion module ISM and may fix the falling body SC.

The opening and closing module OCM may be disposed under the support module SPM and may be horizontally opened and closed. Before the opening and closing module OCM is operated, the falling body SC may be fixed not to be dropped. When the opening and closing module OCM is operated and wings that hold the falling body SC are opened horizontally, the falling body SC may fall in the direction of gravity.

According to an embodiment, the opening and closing module OCM may be opened and closed by an air cylinder opening and closing method. In such an embodiment, when an opening and closing operation button B-OCM (refer to FIG. 2) is pressed, an air may be injected, and the opening and closing module OCM may be horizontally opened and closed by an internal pressure. As a result, the falling body SC may be dropped.

According to an embodiment, the opening and closing module OCM may be opened and closed by an electronic opening and closing method using a servo motor. In such an embodiment, when the opening and closing operation button B-OCM connected to a wire is pressed, the servo motor may be operated by a voltage, and the opening and closing module OCM may be opened and closed horizontally by the servo motor. As a result, the falling body SC may be dropped.

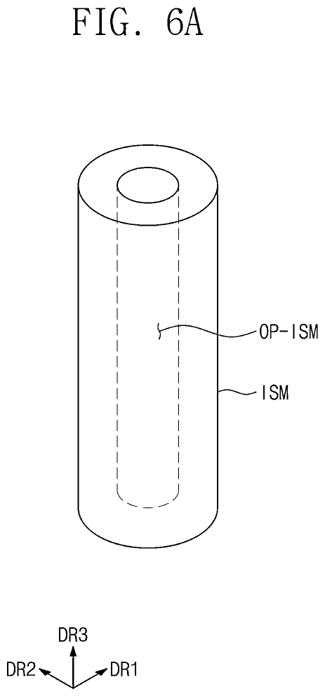

FIG. 6A is a perspective view of the insertion module ISM according to an embodiment of the present disclosure. FIG. 6B is a plan view of the insertion module ISM according to an embodiment of the present disclosure.

Referring to FIGS. 6A and 6B, an embodiment of the insertion module ISM may have the column shape through which the penetration hole OP-ISM is defined, and the falling body SC (refer to FIG. 9A) may pass through the penetration hole OP-ISM. The shape and the size of the penetration hole OP-ISM may be variously modified depending on the type of the falling body SC.

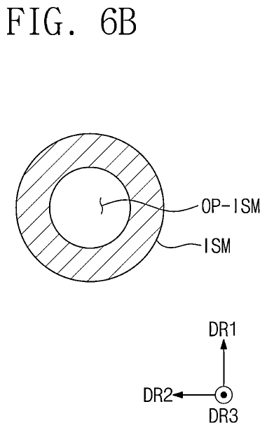

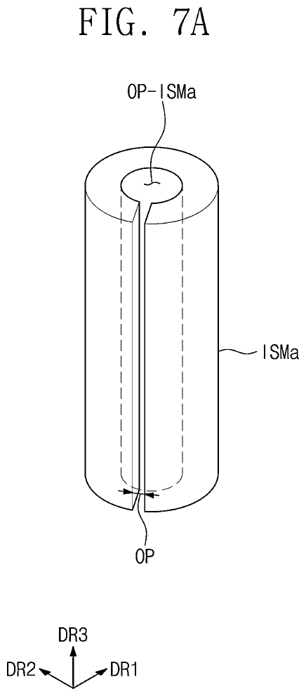

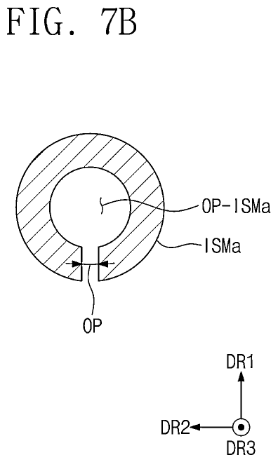

FIG. 7A is a perspective view of an insertion module ISMa according to an alternative embodiment of the present disclosure. FIG. 7B is a plan view of the insertion module ISMa according to an alternative embodiment of the present disclosure.

Referring to FIGS. 7A and 7B, an embodiment of the insertion module ISMa may have a column shape through which a penetration hole OP-ISMa is defined, and the falling body SC (refer to FIG. 9A) may pass through the penetration hole OP-ISMa. An opening OP may be defined through a sidewall of the insertion module ISMa. Accordingly, whether the falling body SC is provided or not may be easily checked through the opening OP.

In such an embodiment, when a pen, which is in use commercially, is applied as the falling body SC, a clip portion of the pen may be positioned to correspond to the opening OP. Accordingly, the falling body SC having a variety of shapes may be guided using the insertion module ISMa provided with the opening OP.

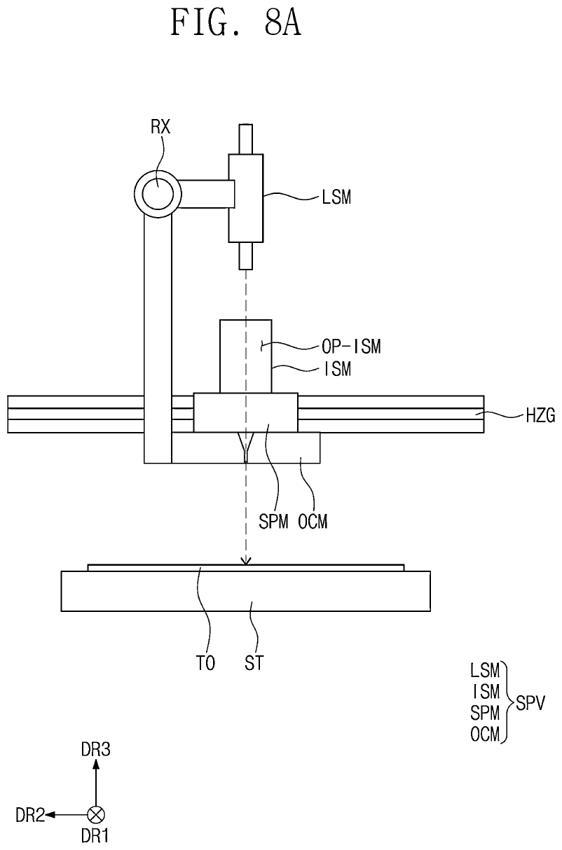

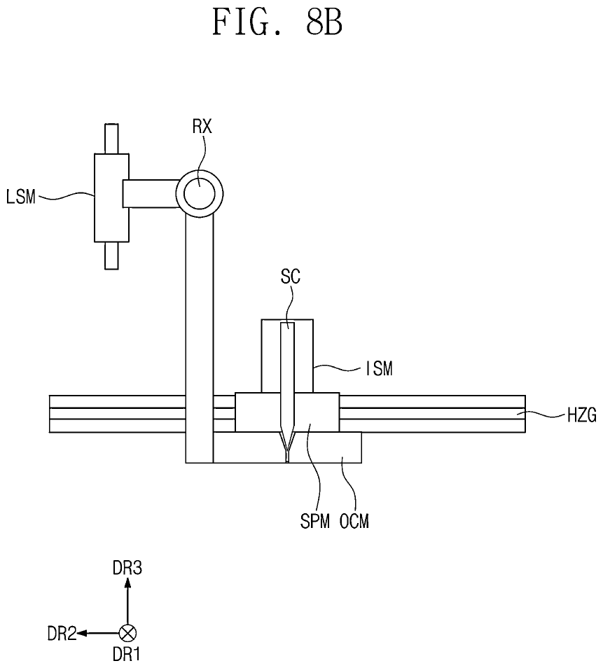

FIGS. 8A and 8B are views of a portion of the test apparatus (refer to FIG. 2) according to an embodiment of the present disclosure.

Referring to FIGS. 8A and 8B, an embodiment of the falling body providing part SPV may include the laser module LSM. The laser module LSM may emit a laser beam through the penetration hole OP-ISM of the insertion module ISM. The laser beam may pass through the penetration hole OP-ISM and may mark a position to which the falling body SC is provided. The drop accuracy of the falling body during the impact resistance test may be improved through the process of checking the evaluation area ET (refer to FIG. 3A) of the test object TO using the laser module LSM, and thus, the test reliability may be improved.

The laser module LSM may rotate about a rotation axis RX with respect to the insertion module ISM after checking the drop position. The laser module LSM may rotate on a plane defined by the second direction DR2 and the third direction DR3. As a result, the laser module LSM may not face the insertion module ISM, as shown in FIG. 8B. The laser module LSM may rotate, and the falling body SC may be mounted in the penetration hole OP-ISM of the insertion module ISM.

FIGS. 9A to 9D are views of falling body SC, SC-1, SC-2, or SC3 according to embodiments of the present disclosure.

Referring to FIGS. 9A to 9D, general commercial products may be used as the falling body for the evaluation in the impact resistance test. However, among the falling bodies in commercial use, an oil-based ballpoint pen has a ball size of about 0.3 millimeter (mm) and a nib portion with a very thin structure, and an active pen has a nip portion with a material that is easily damaged. As a result, the nip portion of the falling body in commercial use may be easily deformed or damaged during the impact resistance test. When the general commercial product is used as the evaluation falling body, deformation of the falling body causes deviations in the test and causes inconvenience, such as loss of time and cost due to frequent replacement of the falling body. In addition, in a case that a body portion of the falling body includes a metal material, a nip portion of the falling body, which is a striking part, is easily magnetized and affects the evaluation, and thus, the accuracy of the test is reduced. Accordingly, in an embodiment, the falling body SC, SC-1, SC-2, or SC-3 that simulate (or has a shape similar to) commercial products may be used to compensate for the deformation of the falling body due to the drop and to improve the accuracy of the test.

An embodiment of the falling body SC, SC-1, SC-2, or SC-3 may have a low center of gravity such that there may be no angular deviation or inclination when the falling body SC, SC-1, SC-2, or SC-3 are falling, and the falling body SC, SC-1, SC-2, or SC-3 may have a cone shape toward the gravity direction such that the drop direction and the drop position may be maintained. The falling body SC, SC-1, SC-2, or SC-3 that simulate various commercial products may be used for the test while satisfying conditions of the low center of gravity and the cone shape.

Referring to FIG. 9A, an embodiment of the falling body SC may include a body portion BO and a pen body portion PO. The body portion BO may include a plastic material, and the pen body portion PO may include a tungsten carbide material or a special alloy steel material. The pen body portion PO may have a shape in which a nib and a ball are provided integrally with each other, and a diameter of the ball may be in a range of about 0.3 mm or about 0.7 mm.

Referring to FIG. 9B, an alternative embodiment of the falling body SC-1 may include a body portion BO, a pen body portion PO-1, the nib portion PP, and a ball BA. The body portion BO may include a plastic material. The nib portion PP and the ball BA may be separately processed and may be inserted into the pen body portion PO-1. The ball BA inserted into the pen body portion PO-1 may have a variety of sizes. Accordingly, in the falling body SC-1, the ball BA having a desired size may be inserted into the pen body portion PO-1.

Referring to FIG. 9C, another alternative embodiment of the falling body SC-2 may include a body portion BO, a pen body portion PO-2, and a ball BA-1. The body portion BO may include a plastic material. The ball BA-1 may be separately processed and may be inserted into the pen body portion PO-2, and the ball BA-1 may be used interchangeably depending on its size.

Referring to FIG. 9D, another alternative embodiment of the falling body SC-3 may have a shape of a ball BA-2. Different from the pen shape, a falling body with a larger contact area and a shape of a round object, such as the ball BA-2, may be used for the impact resistance test.

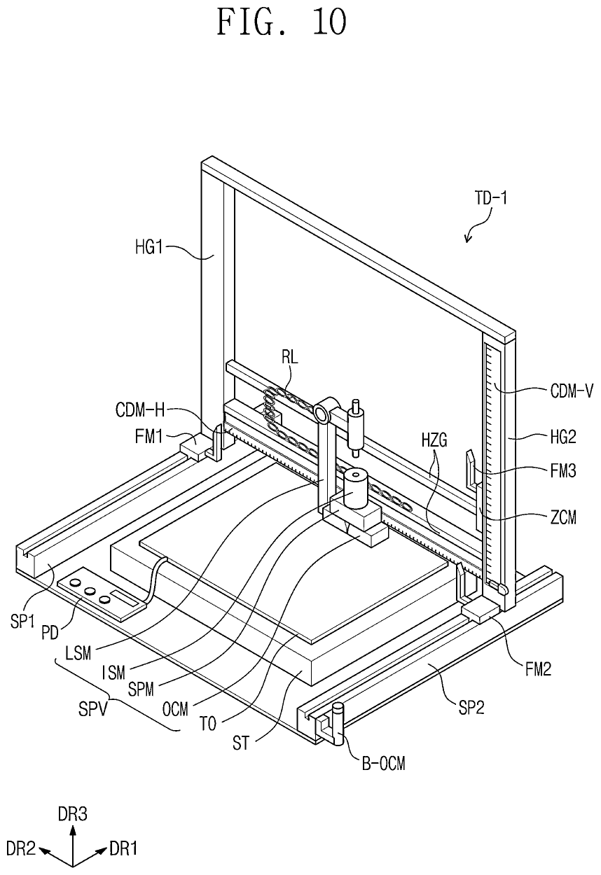

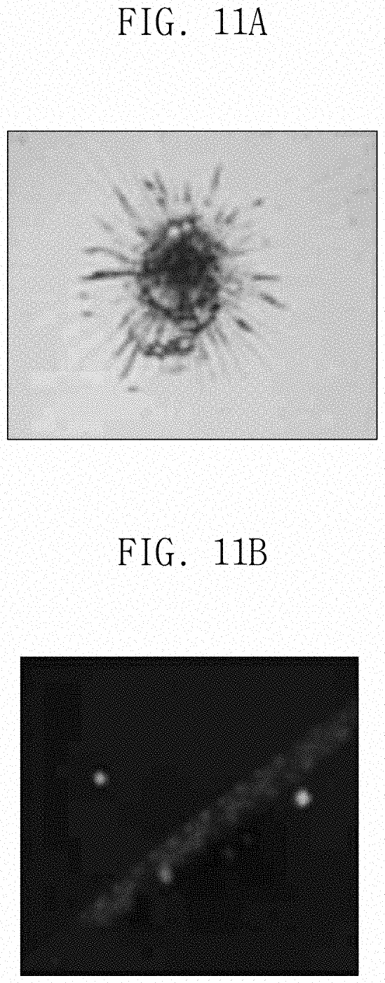

FIG. 10 is a perspective view of a test apparatus TD-1 according to an embodiment of the present disclosure. FIG. 11A is a view of a cracked window according to an embodiment of the present disclosure, and FIG. 11B is a view of a bright spot defect according to an embodiment of the present disclosure. The test apparatus TD-1 shown in FIG. 10 may further include a pattern driver PD in addition to the configuration of the test apparatus TD shown in FIG. 2. In FIG. 10, the same reference numerals denote the same elements thereof as those of FIG. 2, and thus, any repetitive detailed descriptions of the same elements will be omitted.

Referring to FIGS. 10, 11A and 11B, in an embodiment, the pattern driver PD may be connected to the display device DD (refer to FIG. 3B) that is the test object TO. The pattern driver PD may apply a pattern to the display device DD via a signal line.

When the occurrence of a crack on the window WM is determined during the impact resistance test, the impact resistance test may be performed without applying the pattern from the pattern driver PD. The impact resistance test may be performed by dropping the falling body SC (refer to FIG. 9A) from a low height, and then, the falling body providing part SPV may move in the third direction DR3 to continue the impact resistance test. After dropping the falling body SC, it may be determined whether the window WM is cracked using a microscope (not shown). The position at which the crack occurs on the window WM is observed while varying the height of the test, and the impact resistance test is repeatedly performed while the position of the falling body proving part SPV moves in the first direction DR1 or the second direction DR2 at a same height. After the test, when it is observed that no crack occurred at the same height for three times, a maximum height of the heights may be determined as a robust height against the crack of the window WM.

When the bright spot defect is determined during the impact resistance test, the pattern driver PD may apply a black pattern to perform the impact resistance test. The test may be performed by dropping the falling body SC from a low height, and then, the falling body providing part SPV may move in the third direction DR3 to continue the test. After dropping the falling body SC, whether the bright spot defect occurs in the window WM may be observed using a microscope (not shown). The position at which the bright spot defect occurs on the window WM is observed while varying the height of the test, and the test is repeatedly performed while the position of the falling body proving part SPV moves in the first direction DR1 or the second direction DR2 at the same height. After the test, when it is observed that no bright spot defect occurred at the same height for three times, a maximum height of the heights may be determined as an impact resistance level of the window WM.

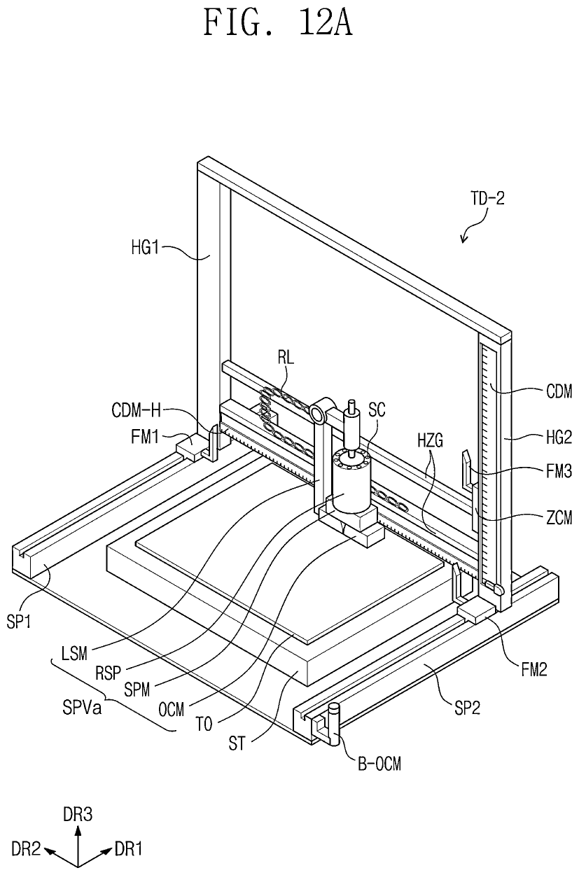

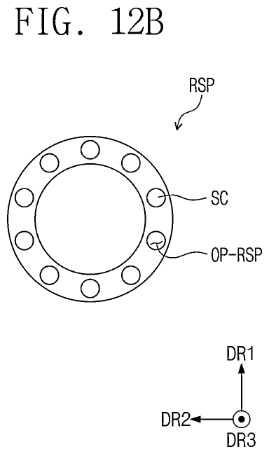

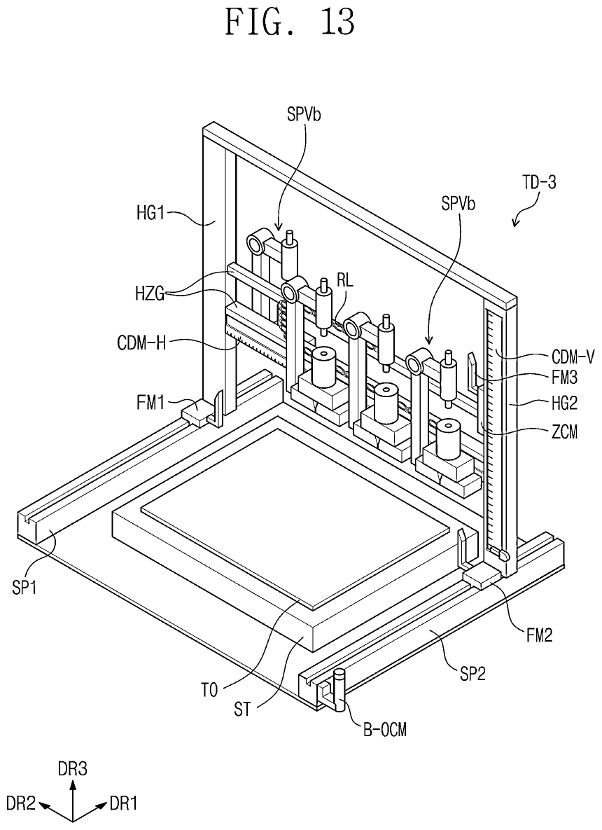

FIG. 12A is a perspective view of a test apparatus TD-2 according to an embodiment of the present disclosure. FIG. 12B is a view of a rotation falling body providing part RSP according to an embodiment of the present disclosure. A falling body providing part SPVa shown in FIG. 12A may include the rotation falling body providing part RSP rather than the insertion module ISM of the falling body providing part SPV shown in FIG. 2. In FIGS. 12A and 12B, the same reference numerals denote the same elements thereof as those in FIG. 2, and thus, any repetitive detailed descriptions of the same elements will be omitted.

Referring to FIG. 12A, the falling body providing part SPVa may include the rotation falling body providing part RSP, a support module SPM, an opening and closing module OCM, and a laser module LSM. The rotation falling body providing part RSP may include a plurality of falling bodies SC. The rotation falling body providing part RSP may provide one falling body SC among the falling bodies SC to the support module SPM and may rotate to sequentially provide the other falling bodies SC to the support module SPM.

Referring to FIG. 12B, the rotation falling body providing part RSP may have a column shape through which a plurality of rotation penetration holes OP-RSP is defined, and the falling body SC may pass through the rotation penetration holes OP-RSP. The plural falling bodies SC may be mounted in the rotation penetration holes OP-RSP. When the rotation falling body providing part RSP in which the falling bodies SC are mounted is used, a time to mount the falling body SC may be reduced, and an efficiency of the impact resistance test may increase. FIG. 12B shows an embodiment with ten rotation penetration holes OP-RSP as a representative example, however, the number of the rotation penetration holes OP-RSP should not be limited thereto or thereby.

FIG. 13 is a perspective view of a test apparatus TD-3 according to an embodiment of the present disclosure. In an embodiment, as shown in FIG. 13, the test apparatus TD-3 may include a plurality of falling body providing parts SPVb. In FIG. 13, the same reference numerals denote the same elements thereof as those in FIG. 2, and thus, any repetitive detailed descriptions of the same elements will be omitted.

Referring to FIG. 13, an embodiment of the test apparatus TD-3 may include the plural falling bodies providing parts SPVb. The falling body providing parts SPVb may be movably coupled with a horizontal guide part HZG. Each of the falling body providing parts SPVb may include a same falling body as each other, e.g., one among the falling body SC, SC-1, SC-2, or SC-3 (refer to FIGS. 9A to 9D), or different falling bodies from each other, e.g., different falling bodies among the falling body SC, SC-1, SC-2, or SC-3. The falling body providing parts SPVb may operate at the same time or at different times. In an embodiment, example, the falling body providing parts SPVb may drop various falling bodies at the same time or at different times, or the falling body providing parts SPVb may drop the same falling bodies SC at the same time or at different times. The evaluation of the impact resistance may be performed in a complex environment using the falling body providing parts SPVb.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A test apparatus comprising:
a stage on which a test object is disposed;
a first support part extending in a first direction;
a second support part extending in the first direction and spaced apart from the first support part in a second direction crossing the first direction with the stage interposed therebetween;
a first height guide part movably coupled with the first support part and extending in a third direction crossing the first direction and the second direction;
a second height guide part movably coupled with the second support part and extending in the third direction;
a horizontal guide part movably coupled with the first height guide part and the second height guide part; and
a falling body providing part movably coupled with the horizontal guide part.

2. The test apparatus of claim 1, wherein the falling body providing part comprises an insertion module, into which the falling body is inserted, and an opening and closing module which controls a drop of the falling body.

3. The test apparatus of claim 2, wherein
the insertion module has a column shape through which a penetration hole is defined, and
the falling body passes through the penetration hole.

4. The test apparatus of claim 2, further comprising:
a support module disposed between the insertion module and the opening and closing module.

5. The test apparatus of claim 4, wherein the insertion module comprises a sidewall through which an opening is defined.

6. The test apparatus of claim 2, wherein the insertion module comprises a transparent material.

7. The test apparatus of claim 2, further comprising:
a laser module which radiates a laser beam to the insertion module to mark a position to which the falling body is provided,
wherein the laser module rotates with respect to the insertion module.

8. The test apparatus of claim 2, wherein the opening and closing module is opened and closed by an air cylinder opening and closing method to drop the falling body.

9. The test apparatus of claim 2, wherein the opening and closing module is opened and closed by an electronic opening and closing method using a servo motor to drop the falling body.

10. The test apparatus of claim 1, wherein the second height guide part comprises a vertical coordinate part extending in the third direction.

11. The test apparatus of claim 10, further comprising:
a zero point control part coupled with the vertical coordinate part, wherein the zero point control part controls a zero point of the vertical coordinate part based on a type of the falling body.

12. The test apparatus of claim 1, wherein the falling body providing part is provided in plural.

13. The test apparatus of claim 1, wherein the falling body providing part comprises:
an opening and closing module which controls a drop of a falling body; and
a rotation falling body providing part which rotates with respect to the opening and closing module and sequentially provides a plurality of the falling bodies to the opening and closing module.

14. The test apparatus of claim 1, further comprising:
a camera module which photographs the test object;
a determination part which determines whether a defect occurs in the test object; and
a control part which controls a position of the falling body providing part, an operation of the camera module, and an operation of the determination part.

15. A test apparatus comprising:
a position guide part; and
a falling body providing part coupled with the position guide part,
wherein the falling body providing part comprises:
an insertion module having a column shape, wherein a penetration hole into which a falling body is inserted is defined in the insertion module;
a support module which supports the insertion module;
an opening and closing module disposed under the support module, wherein the opening and closing module controls a drop of the falling body; and
a laser module which radiates a laser beam via the insertion module to mark a position to which the falling body is provided.

16. The test apparatus of claim 15, wherein an opening is defined through a sidewall of the insertion module and a sidewall of the support module.

17. The test apparatus of claim 15, wherein the insertion module comprises a transparent material.

18. The test apparatus of claim 15, wherein the position guide part comprises:
a first support part extending in a first direction;
a second support part extending in the first direction and spaced apart from the first support part in a second direction crossing the first direction;
a first height guide part movably coupled with the first support part and extending in a third direction crossing the first direction and the second direction;
a second height guide part movably coupled with the second support part and extending in the third direction; and
a horizontal guide part movably coupled with the first height guide part and the second height guide part,
wherein the falling body providing part is movably coupled with the horizontal guide part.

19. The test apparatus of claim 18, wherein the first height guide part further comprises a vertical coordinate part extending in the third direction and a zero point control part coupled with the first height guide part, wherein the zero point control part controls a zero point of the vertical coordinate part based on a type of the falling body.

20. The test apparatus of claim 15, wherein the falling body providing part further comprises a rotation falling body providing part which rotates with respect to the opening and closing module and sequentially provides a plurality of the falling bodies to the opening and closing module.
